(19) United States
(12) Patent Application Publication
(10) Pub. No.: US 2024/0071232 A1
(43) Pub. Date: Feb. 29, 2024

(54) AUTONOMOUS VEHICLE FLEET PRIORITIZATION SYSTEM

(71) Applicant: GM Cruise Holdings LLC, San Francisco, CA (US)

(72) Inventors: Jing Lu, San Francisco, CA (US); Kevin Bozhe Li, Boston, MA (US)

(21) Appl. No.: 17/900,741

(22) Filed: Aug. 31, 2022

(51) Int. Cl. G08G 1/00; G06Q 10/00; G06Q 10/06

(52) U.S. Cl. CPC G08G 1/202; G06Q 10/06315; G06Q 10/06316; G06Q 10/20

(57) ABSTRACT

The disclosed technology provides solutions for improving autonomous vehicle dispatch and in particular, provides solutions for matching autonomous vehicles (AVs) with tasks based on service priorities. Processes of the disclosed technology can include steps for receiving a first task, wherein the first task is associated with a first service type, receiving a second task, wherein the second task is associated with a second service type, dispatching a first autonomous vehicle (AV) to service the first task, and dispatching the second AV to service the second task. The process can further include updating the dispatch of the first AV to service the second task, and updating the dispatch of the second AV to service the first task. Systems and machine-readable media are also provided.

### BACKGROUND

### 1. Technical Field

The disclosed technology provides solutions for improving autonomous vehicle dispatch and in particular, for matching autonomous vehicles (AVs) with various tasks based on service priorities.

### 2. Introduction

Autonomous vehicles (AVs) are vehicles having computers and control systems that perform driving and navigation tasks conventionally performed by a human driver. As such, AVs need to perform many of functions that are conventionally performed by human drivers, such as performing navigation and routing tasks necessary to provide a safe and efficient way of transportation. Such tasks may require the collection and processing of large quantities of data using various sensor types, including but not limited to cameras and/or Light Detection and Ranging (LiDAR) sensors disposed on the AV.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates a block diagram of an example AV dispatch management system, according to some aspects of the disclosed technology.

FIG. 2 illustrates an example of communications between a management system and various AVs, according to some aspects of the disclosed technology.

FIG. 3 illustrates a flow diagram of an example process for matching task assignments to various AVs, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Conventional dispatch services typically assign tasks to a given provider for a specific service type. For example, tasks relating to food delivery can be assigned to certain vehicles (or drivers), whereas tasks related to ridesharing are assigned to a different set of vehicles or drivers. Additionally, conventional dispatch systems do not permit task swapping or updating once dispatch has been initiated. For example, a vehicle en route to perform a food-pickup service task cannot be re-dispatched (or provided with updated task instructions) before the current task (food delivery) is completed. Lastly, conventional dispatch systems cannot perform predictive dispatch, e.g., wherein vehicles are dispatched to a location (or geographic area), based on a forecasted service demand. These constraints of conventional fleet deployments make it difficult to efficiently match, and thereby prioritize, incoming tasks with available vehicles.

Aspects of the disclosed technology provide solutions for improving autonomous vehicle dispatch and in particular, for matching autonomous vehicles (AVs) with various tasks based on service priority. The disclosed technology also provides solutions for implementing predictive dispatch solutions, for example, to re-locate (or pre-emptively position) AVs into locations/areas based on forecasted service demands.

As discussed in further detail below, various aspects of the disclosed technology can be implemented (or facilitated by) a management system (also: dispatch management system) configured to receive, batch, bundle, and/or prioritize various customer requests (or tasks). As used herein, a task may refer to any service that can be provided by an AV, including but not limited to ride-share services, food/grocery delivery, and/or parcel delivery services. In some respects, AV's may be dispatched to provide computer-vision services, such as by performing visual-aid tasks using one or more vehicle sensors (e.g., mounted cameras). Such services may include a wide array of functions, including but not limited to providing lost item search, parking spot finding/identification, price checks (e.g., gas station prices), and/or reservation services e.g., by collecting data about lines outside of restaurants or other venues, etc. Additionally, AV services may include functions that are requested by AV testers/developers, including but not limited to: mapping tasks, maintenance tasks (e.g., charging, cleaning, data offload, etc.), operational tasks (e.g., AV relocating), and the like.

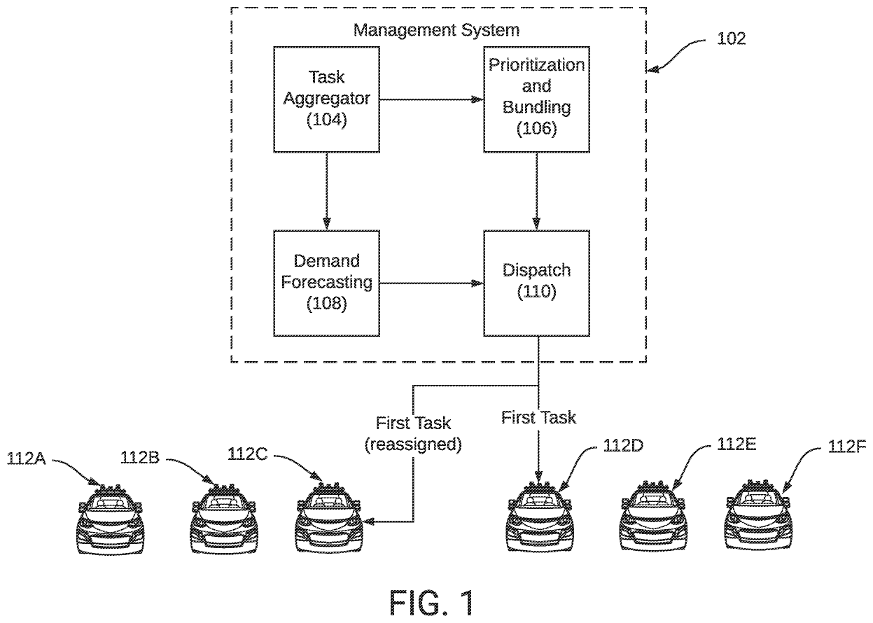

In some aspects, the dispatch management system can be configured to bundle similar tasks, for example, based on various factors such as task similarity and/or task location. Depending on the desired implementation, task similarities may be determined using different criteria, including but not limited to indications of priority or urgency, social/financial benefit, and/or compatibility with other tasks. By way of example, task requests received by a customer may specify bundling constraints, e.g., whereby a customer may specify that that they do not wish to share ride hailing services with other passengers, or that they do not wish to have their items transported in an AV that is also carrying food items, etc. Further details regarding the implementation of a dispatch management system are provided with respect to FIG. 1, discussed below.

FIG. 1 illustrates a block diagram of an example AV dispatch management system 102, according to some aspects of the disclosed technology. Management system 102 includes a task aggregator module 104 that is communicatively coupled with a prioritization and bundling module 106, and a demand forecasting module 108. In turn, prioritization and bundling module 106 and demand forecasting module 108 are communicatively coupled with a dispatch module 110.

Task aggregator 104 can be configured to collect various requests (e.g., customer requests) for a variety of services, as mentioned above. Task aggregator 104 can also provide incoming task requests to prioritization and bundling module 106. Requests (or tasks) aggregated by task aggregator 104 can include information (metadata) specifying a service type (e.g., ride hailing, or food delivery, etc.), as well as service compatibility information, e.g., whether the associated task can be bundled with another task. By way of example, compatibility information may specify the originating customer's willingness to share an AV with another rider, and/or whether they prefer to have items delivered with (or separately from) other deliveries. Task information can also specify location information relating to the associated task/request, such as a start and end location of the request, a deadline in which the task needs to be completed, and/or any prioritization information submitted by the customer. By way of example, customer prioritization information may include indications of customer incentives that have been provided in order to expedite the associated request.

Information about received tasks can also be consumed by demand forecasting module 108, for example, for use in determining/predicting a likelihood of future requests. Forecasting module 108 can make predictions about future incoming requests at various temporal and spatial resolutions. For example, forecasting module 108 may make predictions covering a geographic area that is spanned by vehicles of an AV fleet. As such, temporal and/or spatial aspects of demand prediction can be based on a size of the AV fleet.

Forecasted demand for various tasks or requests can be used to pre-emptively dispatch one or more AVs to a location (or general vicinity) where the request/s are predicted to originate. In such instances, dispatch module 110 can be used to communicate with one or more AVs in an AV fleet, e.g., one or more of AVs 112A, 112B, 112C, 112D, 112E, 112F (collectively AVs 112), to provide relocation instructions. It is understood that a greater (or fewer) number of AVs may be used in an AV fleet, without departing from the scope of the disclosed technology.

Dispatch of one or more of AVs 112 by dispatch module 110 can also be controlled by instructions provided by prioritization and bundling module 106. Module 106 can be configured to bundle requests based on various similarities, such as similarities in the service type associated with different tasks, and/or based on timing or location considerations. By way of example, requests of a similar service type (e.g., food delivery) may be bundled together if they share some location similarities (e.g., proximately located pick-up/drop-off locations) and/or if they share similar temporal parameters (e.g., specified pick-up/drop-off times). In some aspects, two otherwise similar tasks may not be bundled, or may be unbundled, based on the associated compatibility information. By way of example, a customer may indicate that they do not want their delivery items to be bundled with other items, or with items of a specific type (e.g., food). In such cases, prioritization and bundling module 106 can assign tasks or can update tasks delegated to various AVs 112, accordingly.

In some aspects, prioritization and bundling module 106 can be configured to issue and then later update delegated tasks. That is, AVs deployed to service a task may be updated en route to perform an additional task, or to switch to a different task altogether. Notably, task switching between AVs may be performed as between service types. Further to the illustrated example of FIG. 1, AV 112 may be dispatched to complete a first task that is of a particular service type (e.g., a computer-vision task). At a later time, and before the task is completed by AV 112D, dispatch module 110 may re-assign (or re-match) the first task, for example, to AV 112C. In such instances, the first task may be bundled with one or more preexisting tasks that had been assigned to (or matched with) AV 112C. By way of example, dispatch module 110 may determine that the computer-vision service corresponding with the first task is one that can be performed on an existing route of AV 112C, for example, that may be en route to perform a different task of another service type, such as delivery of a food item. As such, it may be more efficient to match the first task with AV 112C, and to assign an altogether different task to AV 112D. In this manner, management system 102 can optimally and continuously ingest newly received tasks, and assign (and re-assign) them to AVs 112 based on new or updated task information (or task metadata).

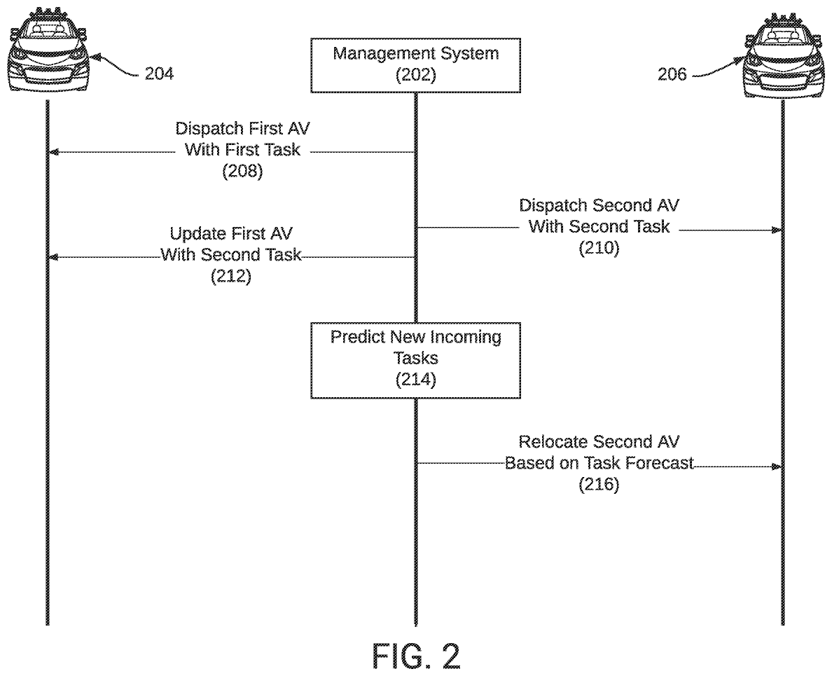

FIG. 2 illustrates an example of communications between a management system 202 and various AVs (e.g., a first AV 204, and a second AV 206). In the example of FIG. 2, management system 202 can perform task collection, forecasting, prioritization/bundling, and dispatch functions, as discussed above with respect to management system 102.

In operation, management system 202 can assign ingested tasks to AVs 204 and 206. For example, the first AV 204 can be dispatched with a first task, e.g., of a first service type (208), whereas the second AV 206 can be dispatched with a second task of a second service type (210). In some instances, the first task and the second task may be of different service types. For example, the first task may relate to a rideshare service, whereas the second task may relate to a food delivery service. Subsequently, management system 202 may re-match task assignments for the first AV 204, and the second AV 206. For example, a dispatch of the first AV 204 may be updated such that the first AV 204 is also assigned with a second task. In this example, the re-bundling of tasks matched with the first AV 204 results in the first AV 204 performing multiple tasks of potentially different service types (e.g., ridesharing and food delivery).

In some aspects, management system 202 may formulate estimates of new future task demands (214). By way of example, such forecasts may be based on historic demand levels for specific tasks and service types, e.g., at certain times/locations. In anticipation of future requests, one or more AVs (e.g., the second AV 206) may be preemptively relocated to service future requests (216). By way of example, it may be forecasted that food delivery requests are likely to be originated at a future time, requiring pick-up of food items in a particular geographic location. In such instances, the second AV 206 may be relocated to the geographic location in preparation for the future requests. By proactively re-locating AV resources based on forecasted demand, service efficiency may be greatly improved across the AV fleet. By way of further example, the need for AV maintenance may be predicted, in which case one or more AVs may be routed to a service station for charging, cleaning or for the performance of other types of AV maintenance.

In some instances, demand forecasting by management system 202 can be used to trigger requests for additional fleet capacity. By way of example, the management system 202 may be used to forecast demand, and to then compute or determine incentives that may be used to enlist third-party AVs.

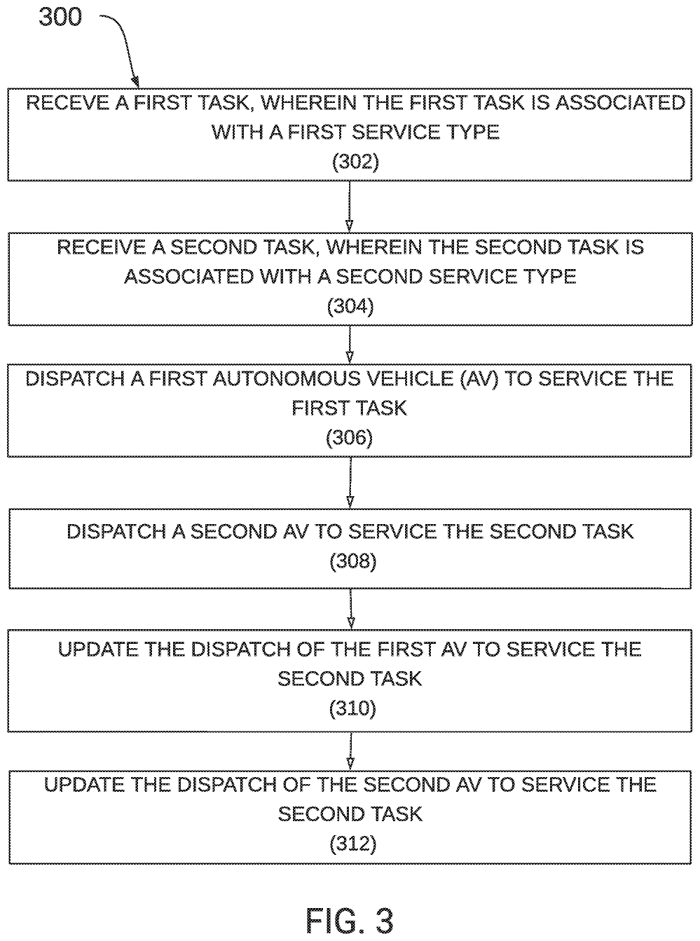

FIG. 3 illustrates a flow diagram of an example process 300 for matching task assignments to various AVs. At step 302, the process 300 includes receiving a first task, wherein the first task is associated with a first service type. At step 304, the process 300 includes receiving a second task, wherein the second task is associated with a second service type. In some instances, the first task and the second task may be of different service types. For example, the first task may relate to a computer-vision service, whereas the second task may relate to a food delivery service. In other approaches, the first task and service tasks may be similar or related task types. For example, the first/second tasks may relate to parcel and food delivery. Other tasks of various other service types (e.g., computer-vision services) may be used, without departing from the scope of the disclosed technology.

At step 306, the process 300 includes dispatching a first autonomous vehicle (AV) to service the first task. At step 308, the process 300 includes dispatching a second AV to service the second task. Depending on the service type for the tasks to be performed by the first/second AV, the dispatch may include pick-up and drop-off instructions. Additionally, in instances where an AV is completing a bundle of tasks, e.g., of the same or different types, the dispatch instructions may specify multiple pick-up and/or drop-off locations.

In some instances, dispatch of the first/second AV may specify a route to be taken by the AV when completing an assigned task, for example, such that one or more additional tasks may be performed on the route, e.g., to a drop-off location.

At step 310, the process 300 includes updating the dispatch of the first AV to service the second task. At step 312, the process 300 includes updating the dispatch of the second AV to service the first task. For example, a dispatch of the first AV may be updated such that the first AV is assigned with the second task. In this example, the re-bundling of tasks matched with the first AV results in the first AV performing a task of a service type that is different from the original task for which the first AV was deployed.

In some aspects, a dispatched AV may be assigned to multiple tasks of different service types. For example, the first AV may be assigned a food-delivery task, as well as a computer-vision service task. Additionally, dispatch of one or more AVs may be performed pre-emptively. For example, a third AV may be dispatched proactively, e.g., to an area where forecasted demand for tasks of a particular service type are determined to be high. By way of example, an AV may be pre-emptively dispatched to an area containing a lot of restaurants, e.g., in anticipation of future food-delivery requests that would require the AV to pick-up items at one or more of the restaurants. That is, AV dispatch may be performed before tasks are assigned to the AV.

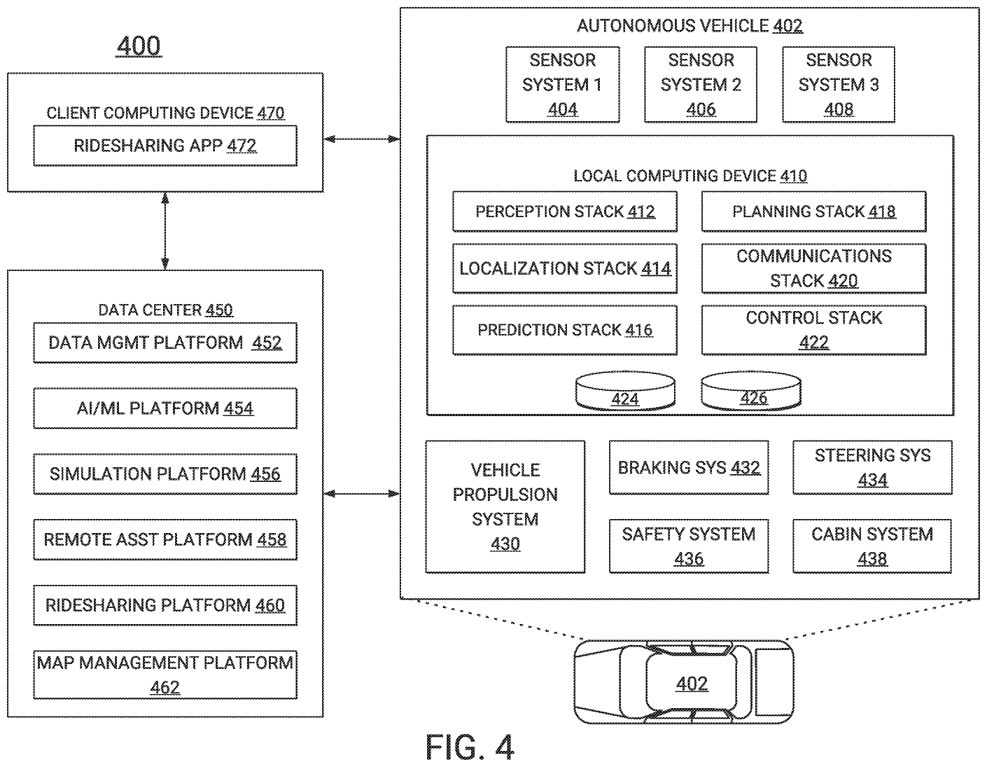

FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

In this example, the AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

The AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

The AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

The perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some embodiments, AV 402 can compare sensor data captured in real-time by sensor systems 404-408 to data in HD geospatial database 426 to determine its precise (e.g., accurate to the order of a few centimeters or less) position and orientation. AV 402 can focus its search based on sensor data from one or more first sensor systems (e.g., GPS) by matching sensor data from one or more second sensor systems (e.g., LIDAR). If the mapping and localization information from one system is unavailable, AV 402 can use mapping and localization information from a redundant system and/or from remote data sources.

Prediction stack 416 can receive information from localization stack 414 and objects identified by perception stack 412 and predict a future path for the objects. In some embodiments, prediction stack 416 can output several likely paths that an object is predicted to take along with a probability associated with each path. For each predicted path, prediction stack 416 can also output a range of points along the path corresponding to a predicted location of the object along the path at future time intervals along with an expected error value for each of the points that indicates a probabilistic deviation from that point.

Planning stack 418 can determine how to maneuver or operate AV 402 safely and efficiently in its environment. For example, planning stack 418 can receive the location, speed, and direction of AV 402, geospatial data, data regarding objects sharing the road with AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. Planning stack 418 can determine multiple sets of one or more mechanical operations that AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct AV 402 to go around the block instead of blocking a current lane while waiting for an opening to change lanes.

Control stack 422 can manage the operation of the vehicle propulsion system 430, the braking system 432, the steering system 434, the safety system 436, and the cabin system 438. Control stack 422 can receive sensor signals from the sensor systems 404-408 as well as communicate with other stacks or components of the local computing device 410 or a remote system (e.g., the data center 450) to effectuate operation of AV 402. For example, control stack 422 can implement the final path or actions from the multiple paths or actions provided by planning stack 418. This can involve turning the routes and decisions from planning stack 418 into commands for the actuators that control the AV's steering, throttle, brake, and drive unit.

Communications stack 420 can transmit and receive signals between the various stacks and other components of AV 402 and between AV 402, data center 450, client computing device 470, and other remote systems. Communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal U-turn lanes; permissive or protected only right turn lanes; etc.). The traffic controls lane can include geospatial information of traffic signal lights, traffic signs, and other road objects and related attributes.

AV operational database 424 can store raw AV data generated by the sensor systems 404-408, stacks 412-422, and other components of AV 402 and/or data received by AV 402 from remote systems (e.g., data center 450, client computing device 470, etc.). In some embodiments, the raw AV data can include HD LIDAR point cloud data, image data, RADAR data, GPS data, and other sensor data that data center 450 can use for creating or updating AV geospatial data or for creating simulations of situations encountered by AV 402 for future testing or training of various machine learning algorithms that are incorporated in local computing device 410.

Data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. Data center 450 can include one or more computing devices remote to local computing device 410 for managing a fleet of AVs and AV-related services. For example, in addition to managing AV 402, data center 450 may also support a ridesharing service, a delivery service, a remote/roadside assistance service, street services (e.g., street mapping, street patrol, street cleaning, street metering, parking reservation, etc.), and the like.

Data center 450 can send and receive various signals to and from AV 402 and client computing device 470. These signals can include sensor data captured by the sensor systems 404-408, roadside assistance requests, software updates, ridesharing pick-up and drop-off instructions, and so forth. In this example, data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

Data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

AI/ML platform 454 can provide the infrastructure for training and evaluating machine learning algorithms for operating AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

Simulation platform 456 can enable testing and validation of the algorithms, machine learning models, neural networks, and other development efforts for AV 402, remote assistance platform 458, ridesharing platform 460, map management platform 462, and other platforms and systems. The simulation platform 456 can replicate a variety of driving environments and/or reproduce real-world scenarios from data captured by AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

Remote assistance platform 458 can generate and transmit instructions regarding the operation of the AV 402. For example, in response to an output of the AI/ML platform 454 or other system of data center 450, remote assistance platform 458 can prepare instructions for one or more stacks or other components of AV 402.

Ridesharing platform 460 can interact with a customer of a ridesharing service via a ridesharing application 472 executing on client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart earbuds, or other smart in-ear, on-ear, or over-ear device, etc.), gaming system, or other general purpose computing device for accessing ridesharing application 472. Client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of data center 450. For example, the AI/ML platform 454 may incorporate the map viewing services for visualizing the effectiveness of various object detection or object classification models, simulation platform 456 may incorporate the map viewing services for recreating and visualizing certain driving scenarios, remote assistance platform 458 may incorporate the map viewing services for replaying traffic incidents to facilitate and coordinate aid, ridesharing platform 460 may incorporate the map viewing services into client application 472 to enable passengers to view AV 402 in transit en route to a pick-up or drop-off location, and so on.

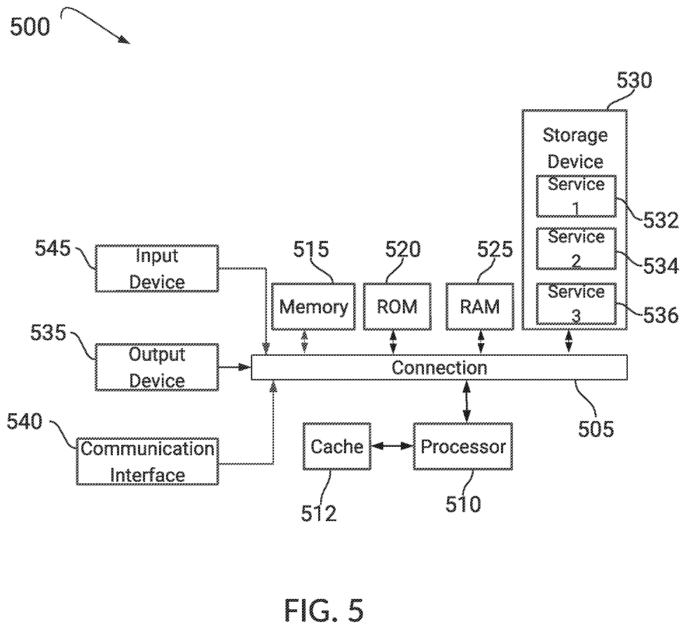

FIG. 5 illustrates an example apparatus (e.g., a processor-based system) with which some aspects of the subject technology can be implemented. For example, processor-based system 500 can be any computing device making up internal computing system 410, remote computing system 450, a passenger device executing the rideshare app 470, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

Computing system 500 can be (or may include) a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a Blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L6), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that causes the system to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. An apparatus comprising:
at least one memory; and
at least one processor coupled to the at least one memory, the at least one processor configured to:
receive a first task, wherein the first task is associated with a first service type;
receive a second task, wherein the second task is associated with a second service type;
dispatch a first autonomous vehicle (AV) to service the first task;
dispatch a second AV to service the second task;
update the dispatch of the first AV to service the second task; and
update the dispatch of the second AV to service the first task.

2. The apparatus of claim 1, wherein the first service type comprises a rideshare service, and wherein the second service type comprises a food delivery service.

3. The apparatus of claim 1, wherein the at least one processor is further configured to:
predict demand for a third task; and
preemptively dispatch a third AV to a location associated with the third task.

4. The apparatus of claim 3, wherein the third task comprises a computer-vision task.

5. The apparatus of claim 4, further comprising:
update a dispatch of the first AV to service the third task.

6. The apparatus of claim 1, wherein to update the dispatch of the first AV to service the second task, the at least one processor is further configured to:
re-route the first AV to provisioning station; and
re-dispatch the first AV after the first AV has been provisioned from the second service type associated with the second task.

7. The apparatus of claim 1, wherein the update of the dispatch of the first AV is based on a demand forecast.

8. A computer-implemented method, comprising:
receiving a first task, wherein the first task is associated with a first service type;
receiving a second task, wherein the second task is associated with a second service type;
dispatching a first autonomous vehicle (AV) to service the first task;
dispatching the second AV to service the second task;
updating the dispatch of the first AV to service the second task; and
updating the dispatch of the second AV to service the first task.

9. The computer-implemented method of claim 8, wherein the first service type comprises a rideshare service, and wherein the second service type comprises a food delivery service.

10. The computer-implemented method of claim 8, further comprising:
predicting demand for a third task; and
preemptively dispatching a third AV to a location associated with the third task.

11. The computer-implemented method of claim 10, wherein the third task comprises a computer-vision task.

12. The computer-implemented method of claim 11, further comprising:
updating a dispatch of the first AV to service the third task.

13. The computer-implemented method of claim 8, wherein updating the dispatch of the first AV to service the second task, further comprises
re-routing the first AV to provisioning station; and
re-dispatching the first AV after the first AV has been provisioned from the second service type associated with the second task.

14. The computer-implemented method of claim 8, wherein updating the dispatch of the first AV is based on a maintenance status of the first AV or the second AV.

15. A non-transitory computer-readable storage medium comprising at least one instruction for causing a computer or processor to:
receive a first task, wherein the first task is associated with a first service type;
receive a second task, wherein the second task is associated with a second service type;
dispatch a first autonomous vehicle (AV) to service the first task;
dispatch the second AV to service the second task;
update the dispatch of the first AV to service the second task; and
update the dispatch of the second AV to service the first task.

16. The non-transitory computer-readable storage medium of claim 15, wherein the first service type comprises a rideshare service, and wherein the second service type comprises a food delivery service.

17. The non-transitory computer-readable storage medium of claim 15, wherein the at least one instruction is further configured to cause the computer or processor to:
predict demand for a third task; and
preemptively dispatch a third AV to a location associated with the third task.

18. The non-transitory computer-readable storage medium of claim 17, wherein the third task comprises a computer-vision task.

19. The non-transitory computer-readable storage medium of claim 15, wherein to update the dispatch of the first AV, the at least one instruction is further configured to cause the computer or processor to:
re-route the first AV to provisioning station; and
re-dispatch the first AV after the first AV has been provisioned from the second service type associated with the second task.

20. The non-transitory computer-readable storage medium of claim 15, wherein the update to the dispatch of the first AV is based on a demand forecast.
